(19) United States
(12) Patent Application Publication
(10) Pub. No.: US 2015/0363878 A1
(43) Pub. Date: Dec. 17, 2015

(54) EXCHANGE TRADED COLLATERAL SYSTEM AND METHODS OF PERFORMING THE SAME

(71) Applicant: Sourna Daneshvar, Evanston, IL (US)

(72) Inventor: Sourna Daneshvar, Evanston, IL (US)

(21) Appl. No.: 14/736,477

(22) Filed: Jun. 11, 2015

Related U.S. Application Data
(60) Provisional application No. 62/011,715, filed on Jun. 13, 2014.

(51) Int. Cl. G06Q 40/04

(52) U.S. Cl. CPC G06Q 40/04

(57) ABSTRACT

An exchange traded collateral system including a memory and a processor, a program executing in the processer that performs the steps of creating an investment package, populating the investment package with investment units, determining the valuation of the investment package based on the investment units in the investment package, creating a collateral package, populating the collateral package with collateral units until the total value of the collateral units in the collateral package equals the value of the investment package, relating the investment package to the collateral package such that the collateral units in the collateral package are adjusted based on the value of the investment package.

### RELATED APPLICATIONS

This application claims the benefit of and the priority from U.S. provisional Application No. 62/011,715 filed Jun. 13, 2014 entitled EXCHANGE TRADED COLLATERAL SYSTEM AND METHODS OF PERFORMING THE SAME, which is incorporated in its entirety herein by reference.

### BACKGROUND OF THE INVENTION

Financial backing of investments and investment packages is becoming more and more of an issue in the investment community. As more investment packages are becoming subject to regulations requiring collateral backing of the investments in an investment package, a need exists for a mechanism to provide collateral to finance or underwrite investments. Current methods of providing backing do allow for flexibility in adjusting the value of the collateral in response to real time market trends.

A need exists for a system that will allow for dynamic financial backing of investments that responds to market trends in real time.

### BRIEF DESCRIPTION OF THE DRAWINGS

Details of the present invention, including non-limiting benefits and advantages, will become more readily apparent to those of ordinary skill in the relevant art after reviewing the following detailed description and accompanying drawings, wherein:

FIG. 1 depicts a block diagram of an Exchange Traded Collateral System suitable for use with the methods and systems consistent with the present invention;

FIG. 2 shows a more detailed depiction of a computer of FIG. 1;

FIG. 3 shows a more detailed depiction of additional computers of FIG. 1;

FIG. 4 depicts an illustrative example of the operation of the Exchange Traded Collateral System of FIG. 1;

FIG. 5 depicts a schematic representation of the collateral analysis unit adjusting the collateral in a collateral package based on a change to the value of the collateral in the collateral package;

FIG. 6 depicts a schematic representation of the investment analysis unit requesting a modification of the collateral package based on a decrease in the value of the investment package; and

FIG. 7 depicts a illustrative example of the operation of the Exchange Traded Collateral System.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

Described herein is a system for backing investment packages with collateral packages and adjusting the value of the collateral package based on the real time market value of the investment package. The system also centralizes available collateral to ensure that collateral us related to a single collateral package.

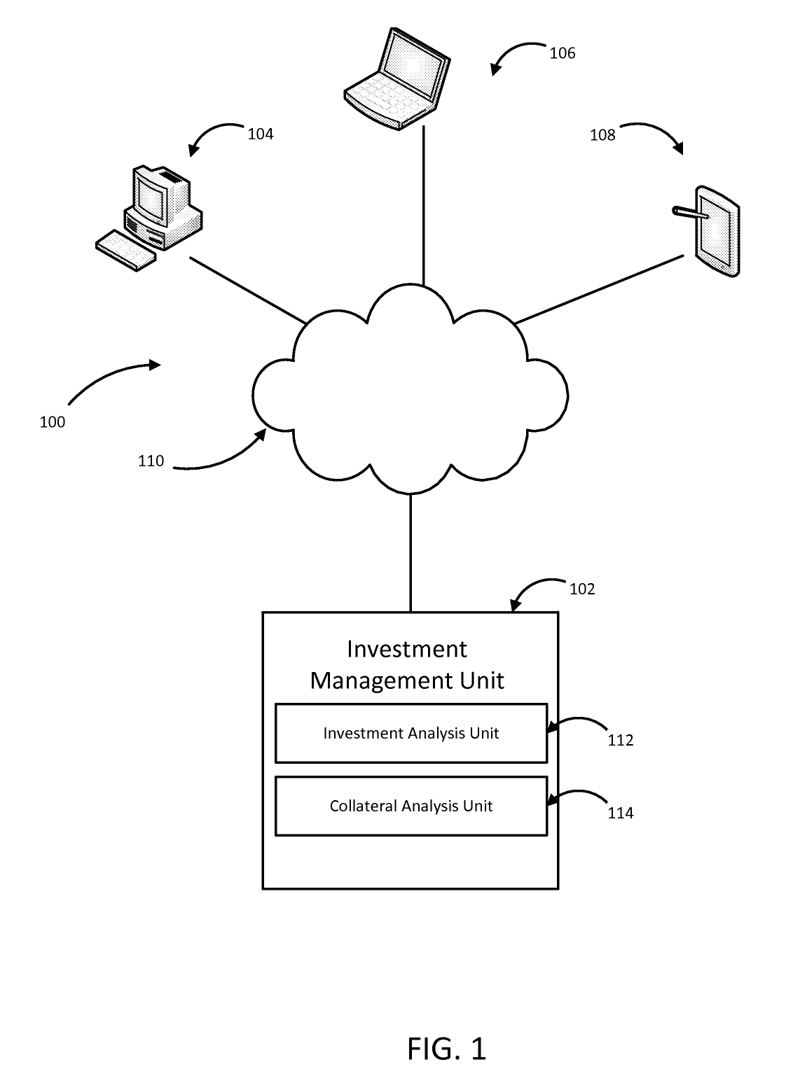

FIG. 1 depicts a block diagram of an Exchange Traded Collateral System (“ETCS”) 100 suitable for use with the methods and systems consistent with the present invention. The ETCS 100 comprises a plurality of computers 102, 104, 106 and 108 connected via a network 110. The network 110 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104, 106 and 108 shown in FIG. 1 is connected to the network 110 via a suitable communication link, such as a dedicated communication line or a wireless communication link.

In an illustrative example, computer 102 serves as an Investment Management Unit (“IMU”) that includes an investment analysis unit 112 and a collateral analysis unit 114. The number of computers and the network configuration shown in FIG. 1 are merely an illustrative example. One having skill in the art will appreciate that the ETCS 100 may include a different number of computers and networks. For example, computer 102 may include the investment analysis unit 112 and the collateral analysis unit 114 may reside on a different computer.

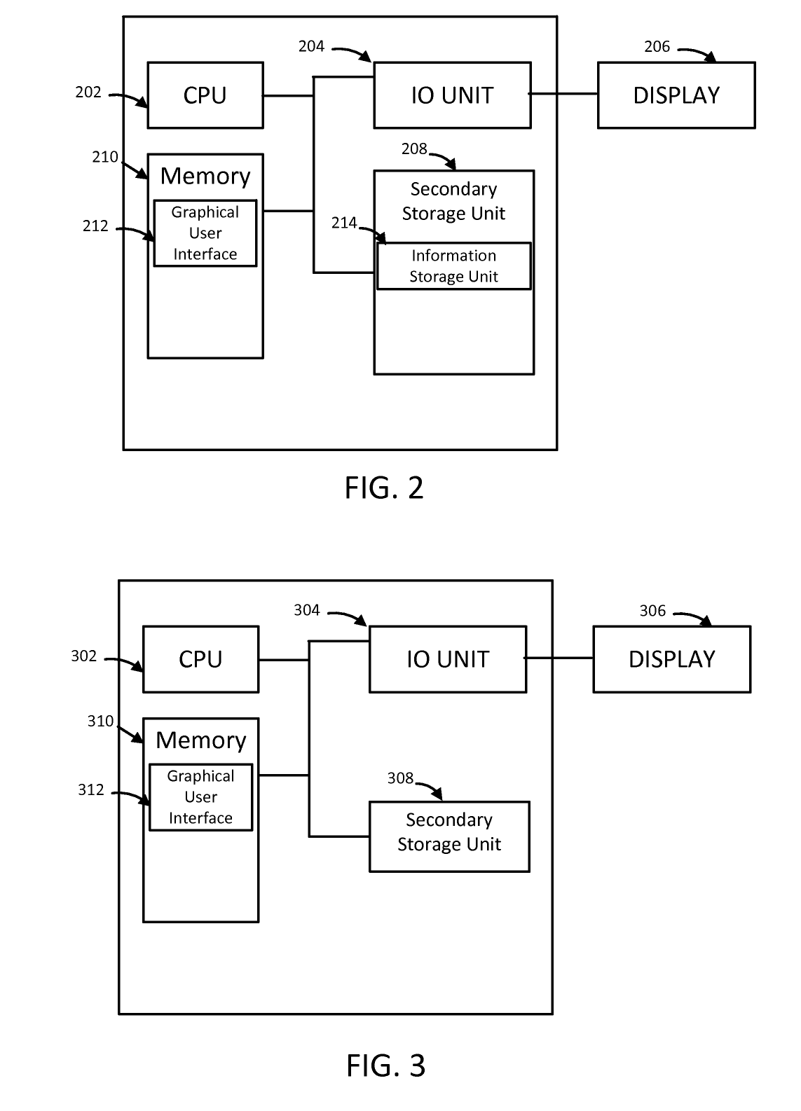

FIG. 2 shows a more detailed depiction of the computer 102. The computer 102 comprises a central processing unit (CPU) 202, an input output (10) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102′s memory 210 includes a Graphical User Interface (“GUI”) 212 that is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a rational database such as, but not including Microsoft's SQL, Oracle or any other database.

FIG. 3 shows a more detailed depiction of the computers 104, 106 and 108. Each computer 104, 106 and 108 comprises a central processing unit (CPU) 302, an input output (IO) unit 304, a display device 306 communicatively coupled to the IO Unit 304, a secondary storage device 308 and a memory 310. Each computer 104, 106 and 108 may further comprise standard input devices such as a keyboard, a mouse, a digitizer, or a speech processing means (each not illustrated).

Each computer 104, 106 and 108's memory 310 includes a GUI 312 which is used to gather information from a user via the display device 306 and IO unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available HTML viewing software such as, but not limited to, Microsoft Internet Explorer, Google Chrome or any other commercially available HTML viewing software.

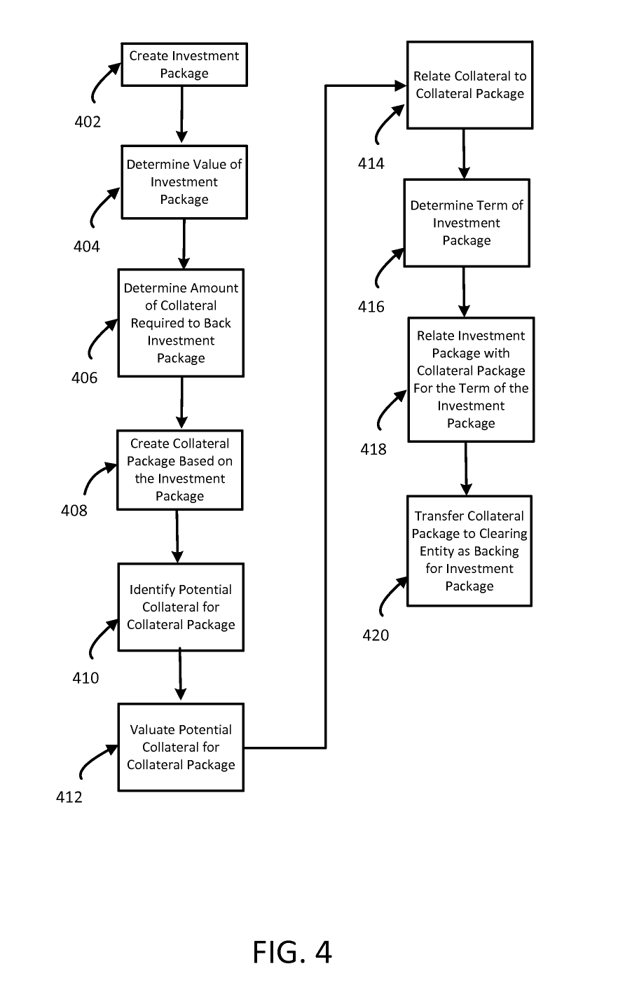

FIG. 4 depicts an illustrative example of the operation of the ETCS 100. In step 402, an investment package is created by the investment analysis unit 112. The investment package may include, but is not limited to, a basis package such as a bond and corresponding derivative or futures hedge, off-setting equity, credit and bond derivative transactions, long short equity and derivative contracts, collateralized loan obligations, mortgages securities and their underlying derivative hedges, commodity contracts in both physical and derivative form, letters of credit for financing such commodity contracts, as well as, letters of credit for other financial transactions, or any other investment package. In step 404, the value of the investment package is determined by the investment analysis unit 112. The value of the investment package is based on the individual values of each investment included in the investment package.

In step 406, the amount of collateral required to back the investment package is determined using the value of the investment package. The amount of collateral required to back the investment package may be based on government regulations, rules and regulations established by the exchange where the investment package will be traded or by the entity establishing the investment package. In step 408, a collateral package is created by the collateral analysis unit 114. Collateral may be any form of real or intellectual property including, but not limited to, US Treasury bonds of different maturity, Japanese Government Bonds of different maturities, collateral worthy sovereign debt instruments, acceptable investment grade corporate credits with AA and above credit ratings, or any other form of collateral. Units of available collateral are stored in the information storage unit 214 along with information on the collateral such as its present market value, the owner of the collateral, the type of collateral, the collateral package the collateral is related to or any other information related to the collateral.

In step 410, the collateral analysis unit 114 identifies collateral units in the information storage unit 214 that may be used to populate the collateral package. In identifying potential collateral to add to the collateral package, the collateral analysis unit may select different collateral units based on predetermined rules concerning the grade and quality of the collateral, a projected value of the collateral over a predetermined period of time, a predetermined type of collateral or any other criteria. In step 412, the collateral analysis unit 114 determines the value of the collateral package by determining the market value of each collateral unit in the collateral package. In one embodiment, the collateral analysis unit uses real time market data to determine the value of the collateral. In another embodiment, the collateral analysis unit 114 projects the future value of the collateral based on the historical value of the collateral or similar pieces of collateral. The collateral analysis unit 114 continues to add collateral to the collateral package until the total value of the collateral package is greater than or equal to the value of the investment package. In step 414, the identified collateral is related to the collateral package in the information storage unit 214 by the collateral analysis unit 114. In relating the collateral units to the collateral package, the collateral analysis unit 114 also prevents each collateral unit from being related to another collateral package. The collateral analysis unit 114 may mark collateral units related to a collateral package as “unavailable” in the information storage unit 214 to prevent the collateral from being allocated to a second collateral package.

In step 416, the term of the investment package is determined by the investment analysis unit 112. The collateral analysis unit 114 sets the term of the collateral package in the information storage unit 214 based on the term of the investment package. When the term of the collateral package expires, each collateral unit in the collateral package is made available for incorporation into other collateral packages, or reverts back to the collateral holder.

In step 418, the collateral package is related to the investment package in the information storage unit 214. By relating the collateral package to the investment package, the value of the collateral package and investment package are logically related such that a change in the value of one of the packages effects the value of the other package. In step 420, the investment analysis unit 112 transfers the investment and collateral packages to a clearing house with the collateral package being used to fund the investment package or an exchange traded package securing the investment package. The investment package may be an exchange traded package cleared by an exchange and or clearing house and financed or swapped for an exchange traded collateral package for which the collateral owner is paid a premium.

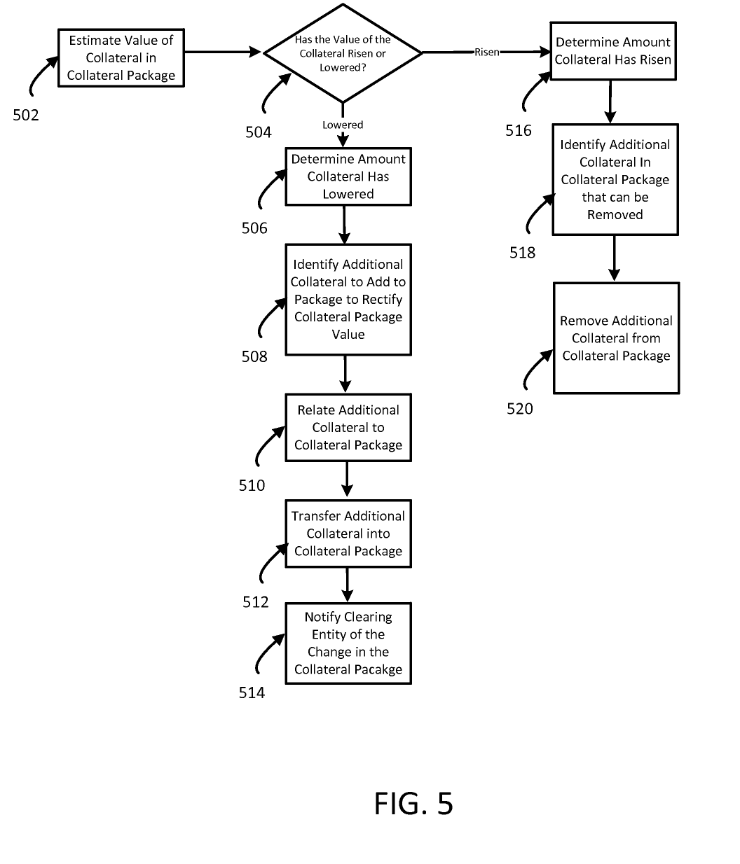

FIG. 5 depicts a schematic representation of the collateral analysis unit 114 adjusting the collateral in a collateral package based on a change in the value of the collateral in the collateral package. In step 502, the collateral analysis unit 114 continuously determines the value of the collateral package. In step 504, the collateral analysis unit 114 determines if the value of the collateral package has increased or decreased from the initial value of the collateral package. In step 506, if the value of the collateral in the collateral package has decreased, the collateral analysis unit 114 determines the amount the collateral has decreased from its initial value. In step 508, the collateral analysis unit 114 identifies additional collateral units in the information storage unit 214 that can be added to the collateral package to bring the value of the collateral package to its initial value. In step 510, the collateral analysis unit 114 relates the identified additional collateral with the collateral package. When the additional collateral is related to the collateral package, the additional collateral become unavailable for relation to other collateral packages. The additional collateral may be marked as “unavailable” in the information storage unit 214 by the collateral analysis unit 114. In step 512, the additional collateral is transferred to the collateral package. In step 514, the collateral analysis unit 114 notifies the clearing entity posting the investment package of the change in the collateral package.

In step 516, if the value of the collateral has increased, the collateral analysis unit 114 determines the amount the collateral has increased. In step 518, the collateral analysis unit 114 identifies collateral in the collateral package that can be removed from the collateral package without causing the value of the collateral package to drop below the initial value. The collateral analysis unit 114, may identify additional collateral that was added to the collateral package due to a drop in the value of the collateral package. In step 520, the collateral analysis unit 114 removes any additional collateral units from the collateral package based on the analysis performed in step 518.

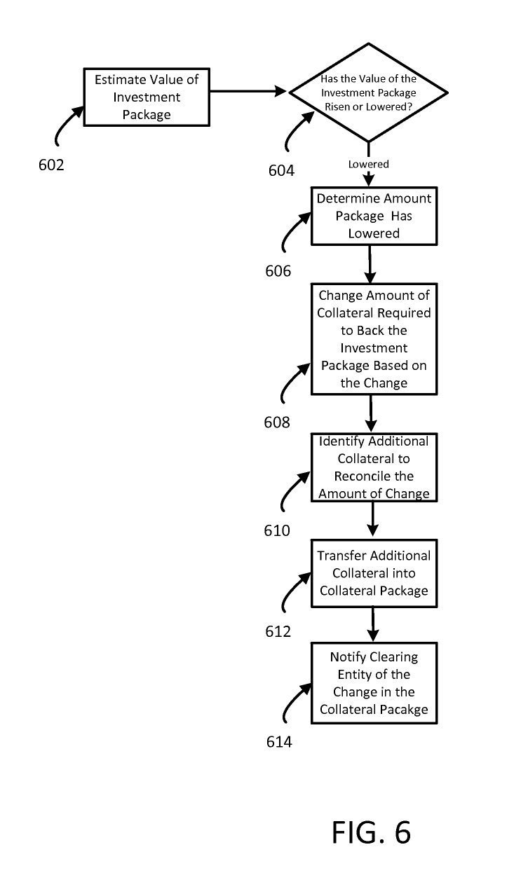

FIG. 6 depicts a schematic representation of the investment analysis unit 112 requesting a modification of the collateral package based on a decrease in the value of the investment package. In step 602, the investment analysis unit 112 continuously determines the value of the investment package. In step 604, the investment analysis unit 112 determines if the investment package value has decreased below the initial value of the investment package. In step 606, if the investment package value has dropped below the initial value, the investment analysis unit 112 determines the amount the investment package value has decreased from the initial value. In step 608, the investment analysis unit 112 changes the amount of collateral required to fund the investment package based on the amount the investment package has reduced in value. In step 610, the collateral analysis unit 114 identifies additional collateral to add to the collateral package to bring the value of the collateral package to the new value provided by the investment analysis unit 112.

In step 612, the collateral analysis unit 114 transfers the additional collateral into the collateral package. When the additional collateral is assigned to the collateral package, the addition collateral is marked as “unavailable” in the information storage unit 214 by the collateral analysis unit 114. In step 614, the collateral analysis unit 114 notifies the clearing entity of the change in the collateral package.

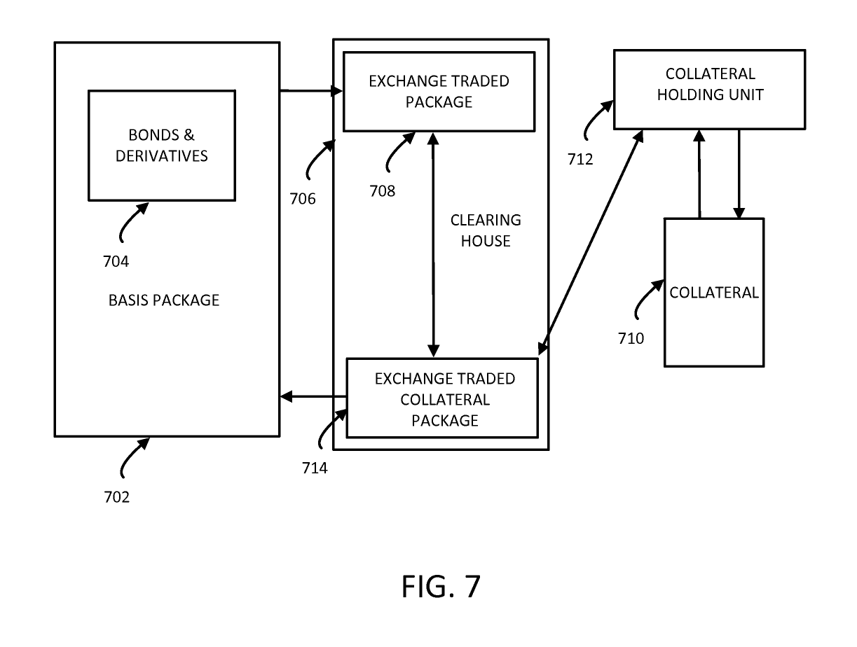

FIG. 7 depicts a illustrative example of the operation of the ETCS 100. The investment analysis unit 112 creates a basis package 702 and populates the basis package 702 with bonds and derivatives 704. The investment analysis unit 112 valuates the basis package 702 based on the current market value of the bonds and derivatives in the basis package. 702. The investment analysis unit 112 creates an exchange traded package 706 with a clearing house 708 to fund the basis package 702.

After the basis package 702 is valuated and the exchange traded package 706 is created, the collateral analysis unit 114 identifies collateral 710 that can be used to fund the basis package 702 in exchange for a portion or all of the exchange traded package 706. The collateral analysis unit 114 then transfers the collateral 710 to the collateral holding unit 712. The transfer of collateral 710 into the collateral holding unit 712 may include the legal transfer of ownership from the collateral owner to a third party. When the value of the collateral 710 in the collateral holding unit 712 is equal to the value of the basis package and/or a set percentage of the basis package which meets the agreed financing, leverage and regulatory guidelines of the counterparties involved 702, the collateral analysis unit 114 transfers the collateral 710 in the collateral holding unit 712 to the clearing house 708 as a collateral package 714 in exchange for the exchange traded package 706 for a term, i.e. period of time defined in the exchange traded package 706.

During the term, the owner of the basis package pays a premium to the owners of the collateral 710 in the collateral package 714. If the value of the exchange traded package 708 drops below the initial value of the exchange traded package 708, the contents of the exchange traded package 708 and collateral package 714 may be adjusted by adding investments to the basis package or collateral to the collateral package compensate for the deamination in value of the exchange traded package 708. If the value of the collateral 710 in the collateral package 714 drops below its initial value, additional collateral 710 may be added to the collateral package 714 to increase the value of the collateral package.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. An exchange traded collateral system including a memory and a processor, a program executing in the processer that performs the steps of:
creating an investment package;
populating the investment package with investment units;
determining the valuation of the investment package based on the investment units in the investment package;
crating a collateral package;
populating the collateral package with collateral units until the total value of the collateral units in the collateral package equals the value of the investment package;
relating the investment package to the collateral package such that the collateral units in the collateral package are adjusted based on the value of the investment package.

2. The system of claim 1, wherein at least one collateral unit is added to the collateral package when the value of the collateral package falls below the value of the investment package.

3. The system of claim 2, wherein at least one collateral unit is removed from the collateral package when the value of the collateral package rises above the value of the investment package.

4. The system of claim 1, wherein at least one collateral unit is added to the collateral package when the total value of the collateral units in the collateral package falls below an initial value of the collateral package.

5. The system of claim 5, wherein at least one collateral unit is removed from the collateral package when the total value of the collateral units in the collateral package rises above the initial value of the collateral package.

6. The system of claim 1, wherein the collateral units are selected from the group consisting of US Treasury bonds, Japanese Government Bonds, sovereign debt instruments or investment grade corporate credits.

7. The system of claim 1, wherein the collateral units are related to one collateral package.

8. The system of claim 1, wherein the value of the investment units are continuously updated.

9. The system of claim 1, wherein the value of the collateral package is continuously updated.

10. The system of claim 1, wherein the collateral package is related to one investment package.

11. An exchange traded collateral system including:
an investment analysis unit creates an investment package, populates the investment package with investment units and determines the valuation of the investment package based on the investment units in the investment package;
an collateral analysis unit that creates a collateral package, populates the collateral package with collateral units until the total value of the collateral units in the collateral package equals the value of the investment package and relates the investment package to the collateral package such that the collateral units in the collateral package are adjusted based on the value of the investment package.

12. The system of claim 1, wherein the collateral analysis unit adds at least one collateral unit to the collateral package when the value of the collateral package falls below the value of the investment package.

13. The system of claim 12, wherein he collateral analysis unit removes at least one collateral unit from the collateral package when the value of the collateral package rises above the value of the investment package.

14. The system of claim 11, wherein he collateral analysis unit adds at least one collateral unit collateral package when the total value of the collateral units in the collateral package falls below an initial value of the collateral package.

15. The system of claim 15, wherein he collateral analysis unit removes at least one collateral unit from the collateral package when the total value of the collateral units in the collateral package rises above the initial value of the collateral package.

16. The system of claim 11, wherein the collateral units are selected from the group of US Treasury bonds, Japanese Government Bonds, sovereign debt instruments or investment grade corporate credits.

17. The system of claim 11, wherein the collateral units are related to one collateral package.

18. The system of claim 11, wherein the investment analysis unit continuously updates the value of the investment units.

19. The system of claim 11, wherein collateral analysis unit continuously updates the value of the collateral package.

20. The system of claim 11, wherein collateral analysis unit relates the collateral package one investment package.
